(19) United States
(12) Patent Application Publication
(10) Pub. No.: US 2006/0059161 A1
(43) Pub. Date: Mar. 16, 2006

(54) Signaling apparatus and method

(76) Inventors: Peter R. Millett, Wembley Downs (AU); Vincent H. Turner, Dalkeith (AU); Nicholas G. Randolph, Perth (AU)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/158,303

(22) Filed: Jun. 21, 2005

Related U.S. Application Data
(63) Continuation of application No. 10/054,723, filed on Nov. 12, 2001, now abandoned.
Application No. 10/054,723 is a continuation-in-part of application No. PCT/AU00/00429, filed on May 11, 2000.

(30) Foreign Application Priority Data
May 11, 1999 (AU) PQ0304
Jun. 23, 1999 (AU) PQ1172

(51) Int. Cl. G06F 17/30

(52) U.S. Cl. 707/10

(57) ABSTRACT

A method of facilitating interactive communication between clients providing services and/or products and prospective users thereof. The method provides access to a database of at least one client's user interest data on a network, permits network access to the user interest data by a user via a remote interface, and receives a selection by the user of the client's user interest data and receives entry by the user of user-specific data. Access is provided to processing software which processes the user-specific data and the selected user interest data to produce response data, and at least one recipient nominated by the client is provided with access to equipment which automatically exports the response data.

### RELATED APPLICATIONS

This application is a continuation-in-part of International Patent Application Number PCT/AU00/00429, filed May 11, 2000, which claims priority to Australian Patent Application Numbers PQ0304, filed May 11, 1999 and PQ1172, filed Jun. 23, 1999.

### FIELD OF THE INVENTION

This invention relates to apparatus and methods of signaling.

The invention has particular application to signalling apparatus for, and to methods of facilitating interactive communication between clients providing services and/or products and prospective users thereof.

This invention has particular application to an Internet-based messaging system enabling potential customers to send real-time purchasing messages to purveyors of goods and services, and for illustrative purposes the invention will be described with reference to this application. However, it will be envisaged that the present method will find application in many fields for which real-time signaling from users on the Internet or other networks would be useful, such as remote control processes enabled via the telecommunications network and the validation of electronic document transmission.

### BACKGROUND OF THE INVENTION

The Internet is widely used by business and the public at large as a forum for locating goods and services. The sites invariably include contact details of the conventional type, such as street address, and telephone and fax numbers. The sites usually include email contact details, and may include individual sales personnel details, with direct phone and email details. Some sites include provision for making purchases directly online using a credit card.

The most immediate form of contact in e-commerce is the email. The email message must be compiled in full with the sender's details, the purchase instructions and/or the details of the enquiry. The message is then sent to a mail server from which the purveying business must retrieve the message. In most cases the retrieval will not be immediate, since most users and businesses do not maintain a full time connection to the net or only periodically check their email.

It is a well-known principle of salesmanship that a sale is most likely to be concluded where the prospective client does not have time to go cold on the sale. The so-called cooling off period is an inherent disadvantage of e-commerce sites that rely on email to open dialogue with a sales person.

In the case of credit card purchases, all of the same details as well as the credit card details must be entered into a screen for each purchase. The screen is basically a graphic user interface for an email system in any case. The key client data is subject to the same delays in response as ordinary email even if the credit card details are directed through the web server hosting the site to the credit company. In any case, credit card transactions on the web are regarded with great suspicion by a large proportion of the public, with good reason. This mistrust is one embodiment of a more general mistrust of technology-based, personal-contactless sales of goods and services, irrespective of their safety in fact.

In some cases, the goods and services offered are of a nature that requires a personal opportunity to close the sale or counsel the client.

It remains more likely that a person contacting a business for the first time, or other than by reputation, will complete the purchase having made human contact, rather than by committing details to the net without such contact. Thus the client has a cooling off opportunity in many cases even where the sale can physically be made immediately.

The site www.redrock.com.au is a gateway site for sending messages to telephone handsets utilizing short message services (SMS) on the GSM digital cellular telephone networks used in Australia. As such, the site offers a SMS sending service to subscribing users who know the identity and contact details of the person with whom they wish to communicate. The system essentially provides a subscriber-access means of sending short messages without subscribing to the SMS facility per se. The system is not adapted for use in e-commerce since the users must first be subscribers, thus limiting the market. The important immediacy of contact from the selling site is not present, and the business's SMS contact details must be known before a message can be sent.

America Online (AOL) offers a free “instant messaging service”, wherein a user on the web may send real-time messages or chat with any other user. However, the other user must also be simultaneously logged in to the web, and must of course be an AOL instant messaging member. Accordingly, the system is incapable of providing the instant response required by e-commerce to reduce cooling off.

### SUMMARY OF THE INVENTION

The present invention aims to provide an alternative to known systems and methods of the above type.

In one aspect the invention resides broadly in a method of facilitating interactive communication between clients providing services and/or products and prospective users thereof, the method comprising:

providing access to a database of at least one client's user interest data on a network;

permitting network access to the user interest data by a user via a remote interface;

receiving a selection by the user of the client's user interest data;

receiving entry by the user of user-specific data;

providing access to processing software which processes the user-specific data and the selected user interest data to produce response data, and

providing at least one recipient nominated by the client with access to equipment which automatically exports the response data.

As used herein the term “database” includes within its scope and meaning both the database per se and the database manager presented to the user by the remote interface, the meaning to be ascribed in any particular instance to be determined by context.

As used herein the expression “client” refers to an entity providing products or services as specified and which may be regarded as a client of the entity operating the method, or providing the signalling apparatus, of the present invention.

As used herein the expression “user interest data” refers to data concerning the services or products provided by the client and which could be of interest to a prospective user thereof.

In another aspect this invention resides broadly in a signalling apparatus for facilitating interactive communication between clients providing services and/or products and prospective users thereof, the signalling apparatus comprising:

a database of at least one client's user interest data on a network;

a remote interface permitting network access to the user interest data by a user, selection by the user of a client's user interest data and entry by the user of user-specific data;

processing software which merges the user-specific data and the selected user interest data to produce response data; and

a response module which automatically exports the response data to at least one recipient nominated by the client.

It will be appreciated that this invention is capable of being implemented on the Internet, and the present invention will be understood to cover situations where servers or databases or browsers may be located in other countries.

Accordingly, the expression “providing access” is to be understood to refer to both direct and indirect access in the sense that indirect access refers to the situation where access is allowed, by a web page for example, to an intermediate computer located onshore or offshore in another country, which computer then provides direct access to the database, software or hardware which may be located onshore or offshore.

If the data base is located onshore, the method further comprises establishing and/or maintaining the database.

If the user-specific data and the selected user interest data are processed onshore, the method further comprises processing the user-specific data and the selected user interest data to produce the response data.

If the response date is exported from onshore, the method further comprises automatically exporting the response data to the at least one recipient.

It will be appreciated that the invention also relates to the operations of a user in practicing the invention and accordingly the invention also resides broadly in a method for a user to interactively communicate with a client providing services and/or products, the method comprising:

accessing a database of at least one client's user interest data on a network via a remote interface;

selecting user interest data and entering user-specific data whereby processing software is accessed which processes the user-specific data and the selected user interest data to produce response data which is then automatically exported to at least one recipient nominated by the client, and

communicating with the at least one recipient.

The database of user-interest data preferably includes a client-specific identifier for each client. The database of user-interest data may be selected from any remote access database such as a web server database, subscriber database or other open or closed user group database. The users may an open user group with respect of the database in order to widen the potential market reach. The user-interest data may of course be anything that requires or elicits a user-specific response from the user. For example, the user-interest data may include product or service information in the light of which the client is encouraged to make a purchase response. Alternatively, the user-interest data may include information relating to the client's users or potential users.

The interface will be determined as to its fundamental nature by the mode of access to, and the nature of, the database. The interface may be user interface, such as a command interface or a graphical user interface (GUI). For example, a TTY (teletypewriter) type terminal emulation may be appropriate to access text databases and allow a user to enter command-line type information. However, it is envisaged that for most applications a user interface will comprise a web browser front-ending the graphic user interface of a personal computer, linked by modem, router or network cable to the database server. As the digital services networks, such as cable, enable the technology to become more widely available it is envisaged that interactive systems, such as interactive digital television, may also provide user access. Alternatively, the interface may be an interface between software programs and/or hardware, such as an application program interface. For example, upon registering a nominated event, an application may be programmed to send user-specific data through a communication application to the database.

The response means may take any form consistent with the making of a substantially immediate response to the provision of the user-specific data. The response means may be particularly adapted to a constrained set of user-specific data received and an appropriate constrained corresponding-data response to be elicited. For example, the response means may comprise software and/or hardware configured to accept inter alia a client telephone number as the user-specific data and to make a call to a user- or provider-selected representative's telephone or SMS delivering that number in text or voice respectively. Alternatively, the response means may initiate the telephone call to the representative and immediately call back the user to elicit substantially immediate interpersonal communication. On the other hand, the user-specific data may be less constrained, such as free text, the response means being adapted to relay the data in toto or to preprocess same prior to transmission to text facilities off network such as TTY or SMS.

To assist in communication between parties across differing media and devices, the response means may include a switch for selecting a suitable path for sending the response data to the recipient. This may allow communication between two or more communication devices on any platform on any carrier. Email to mobile phone, fax to voicemail, ICQ (an online instant messaging program) to pager and Web to computer interfaced telephony (CIT) are just a few examples of switching capabilities of the invention as described.

The response means may also screen, filter or monitor the user-specific data and only export response data upon receipt of an identified user-specific data. For example, a salesperson, on the road, may request that only email from a particular sender be sent to his laptop or mobile phone.

In other embodiments, the response may be directed to a third party. For example, a searching service may have libraries as clients and may have a website offering library search services on a user-interest database comprising the consolidated index of the library clients. Upon completion of a search of the index by a user, the site may provide to the user some provider-specific contact data, and prompt the user to enter personal user-specific data such as a return phone number, fax, message bank, email, pager or other data. In real time, the data may be transmitted to the library and contact with the user initiated. The issues of copy cost, postage and supply of for example document copies may be expedited and thus avoid cooling off.

In other embodiments, the user-specific data need not be contact details at all but may instead amount to user-specific instructions. For example, the instructions may be associated with a security service for existing subscribers such as businesses, banks and the like, with workers working late or shift work, allowing them to hit panic button on screen or the like. For a further example, an integrated security concern may have a web site having, as user-interest data a description of the services offered, such as a security check of a property for a price. The user-specific data may for example include a street address, whereby the user-specific data results in a security response such as a specific patrol visit to the address. The response means generated data, for example supply key information to an off network system selecting the GPS location of the nearest security unit to the user address, which data may be represented by a key for the user to select to confirm sending of instructions. The actual identity and location of the patrol is irrelevant. The response to forwarding of the user-specific data is the sending by the server of a command to an off-network radphone, mobile phone, GPS linked RT signal to the mobile patrol or the like, upon receipt of which the request may be immediately serviced.

In other embodiments, the user-specific data may be an event. Many people, businesses and services require regular updates of events or occurrences. For example, updating of the approval of a loan in a bank's computer system may automatically trigger user-specific data, such as email, message or the like, to be sent to the database. In turn, the database may respond by informing relevant people, such as brokers, real estate agents or the loan applicant, of the approval of the loan according to the relevant person's communication device (email, mobile, pager, fax). In this case, the database of user-interest data may include information relating to the relevant people that the bank desires to notify about the loan approval. The remote interface may be an interface between the bank's computer system and the database, whereupon registering the event the bank's computer system automatically notifies the database of the loan approval.

The user-specific data may be retained on the database against future contact by the same user, or to compile a useable database of client details for further marketing uses. The user-specific data may also be reflected back to the user interface and encoded in a cookie or other program established under the user interface. By this means, the user does not need to reenter the user-specific data for each access of the database. Suitably, the data is retained on the user's equipment in a standardized form, whereby the data may be sent on the user's request to any provider using the system of the present invention. In yet further embodiments of the present invention, the user information may be sent to any, preferably a registered, provider whose website is accessed by the user, whereby the user may be targeted in future marketing. The user files of the providers may be returned to a central database in order to develop a profile of e-commerce browsing habits for a particular user or pluralities of users grouped by type of user-specific data. Such accumulation of data from the user to selected suppliers and/or to a central database may of course be subject to appropriate privacy or consent checks.

In essence, the unique user data may serve as a tag for any document or data generated by the user, such that the tag uniquely identifies the user to any member site that the user may access. The data is preferably encrypted to exclude the information from non-member sites. Upon receipt of the encrypted tag, the member site may at its discretion institute for example an immediate telephone call to or pager or chat session with the user. The encryption may be made document-specific, whereby any alteration of the document renders the encrypted user data tag indecipherable, with our without alerting a central database as to the potentially falsified document.

Accordingly, in another aspect, this invention relates to a document validation method including the steps of providing software for users on the network adapted to provide an encrypted key on documents provided by the user, said encrypted key including user-specific data and each key being encrypted by the document whereby tampering is evident, and enabling the same or other user to receive such documents and determine the identity of the sender from the user-specific data.

In this context, “document” is to be construed widely to include any file be it program, text or image or other assembly of electronic data.

In a further aspect this invention also resides broadly in a method of validating the transmission of an electronic document over a network between users thereof, the method comprising:

providing access to a database of user-specific data on the network;

permitting access by a user to the database via a remote interface whereby the user may transmit an electronic document to a recipient nominated by the user;

receiving entry by the user of user-specific data;

encrypting the user-specific data;

providing access to processing software which processes the encrypted user-specific data and data corresponding to the electronic document to produce encrypted document-specific transmission data, and

providing the recipient with access to equipment which automatically exports the transmission data.

As explained above the method of the present invention can be used on the internet with various of the components located either onshore or offshore and accordingly the expression “providing access” is to be accorded the same meaning as above.

If user-specific data and data corresponding to the electronic document are encrypted onshore, the method further comprises processing the encrypted user-specific data and data corresponding to the electronic document to produce encrypted document-specific transmission data.

If the transmission data is exported from onshore, the method further comprises automatically exporting the transmission data over the network to the recipient nominated by the user.

Upon receipt by the recipient of the exported transmission data, a number of indications may be made in accordance with preferred embodiments of the invention. Thus it may be evident if the document has been tampered with, the identity of the user transmitting the document may also be evident, and the user transmitting the document may be automatically alerted if it is evident that the document has been tampered with.

The software may work in a stand-alone manner or may be associated with a specific web site. For example, the software may be a distributable item, whereby the software operates on the user's hardware operating in stand-alone mode. Alternatively, the software may be usable in conjunction with a web site functioning as a DX site. In such cases the web site may additionally function as a further validity checking site.

The user information may, for example, permit the recipient to access information such as the sender's phone number whereby a voice check may be made.

The various embodiments of the above-described inventions may be implemented as computer software executing in distributed computing system. In many of the embodiments, the software may be a client/server or a three-tier type application. Generally, the interface runs on the user's computer or other communication device (first or client tier). The middle tier is the response means which may be located on a server or other shared computer. The third tier includes the database and a program to manage read and write access to it. Generally, the database runs on a database server. It is to be appreciated that a person skilled in the art will be able to or have resources to develop suitable software applications according to the specified embodiment of the invention. The modularity on the invention makes it easier to modify or replace one tier without affecting the other tiers. This enables the user or client to operate, in most cases, independently of any dedicated hardware, software or infrastructure. In the case of event messages, a custom written patch may be incorporated into the user's existing operation software.

In a further aspect this invention resides in a computer based machine including a response means of the signalling apparatus as described above.

In a still further aspect, this invention resides in a computer based machine including a database of user-interest data of the signalling apparatus as described above.

### BRIEF DESCRIPTION OF THE DRAWINGS

In order that this invention may be more readily understood and put into practical effect, reference will now be made to the accompanying drawings which illustrate examples of embodiments of the invention and wherein:

FIG. 1 shows several computers or interactive systems connected via the Internet making use of the on-line messaging system according to one embodiment of the invention;

FIG. 2 shows a pop-up window presented to a user;

FIG. 3 is an alternative embodiment to the embodiment of FIG. 1,

FIG. 4 illustrates a further embodiment of the invention enabling operation over different geographical locations, and

FIG. 5 is a simplistic representation of communication over differing communication devices in accordance.

### EXAMPLES OF MODES FOR CARRYING OUT THE INVENTION

### EXAMPLE 1

In one of the more widely usable embodiments of this invention, the ability to send a message from an Internet site to a mobile phone, specified by a unique identifier, is provided for. In one form a user may browse the Internet, locate product, service or other information that they wish to know more about, and click on a button marked “Ring Me Now”. This button brings up a dialog box requesting the user to enter a small message accompanied by a return phone number and their full name. After clicking send, the message is sent via the Internet to a unique identifier database exchange server, hereinafter referred to as “the UIDBXS”. At the UIDBXS the message is merged with details pertaining to the destination carrier and phone number. The now completed message is transmitted via the Internet to the destination carrier and then to the client's phone. Upon receiving the message, the client calls the user and sets up verbal communication.

There are a number of important aspects of the invention that are combined in this embodiment. The first involves the registration of the client with the UIDBXS. After deciding to use the messaging facility the client must register by submitting details such as their mobile/pager number, their mobile/pager carrier, form of payment and other voluntary details. Through the registration process the client is assigned a unique identifier that is used for future identification by the UIDBXS.

Once registered with the UIDBXS the client can proceed to set up their web site to incorporate the message passing facility. In its simplest form this may be some text boxes in which the user places their message, contact name and phone number, and a “submit” style button for sending the message. Upon pressing the button the message and the unique identifier, which is buried in the HTML coding of the page, are sent to the UIDBXS.

The UIDBXS receives the message, name, phone number and the unique identifier information from the Internet. If this is the first time a user has sent a message through the UIDBXS they are assigned a unique identifier. This is sent back to the user in the form of a cookie as part of the “confirmation of message sent” web page.

Using the unique identifier as a look up value, the UIDBXS searches the database to locate the appropriate record. Upon finding a match it extracts the phone number and carrier from the record. As each telco currently uses different transmission formats the appropriate format needs to be extracted from the database. Once the format of the message has been identified the phone number, message and any other parameters are combined in the correct order to form the Telco-Message. This is then transmitted via the Internet to the telco, who then sends it to the client's mobile/pager. This step may become redundant in time as the relevant communications and competition authorities force telcos to standardise or at least comply with all formats of incoming data.

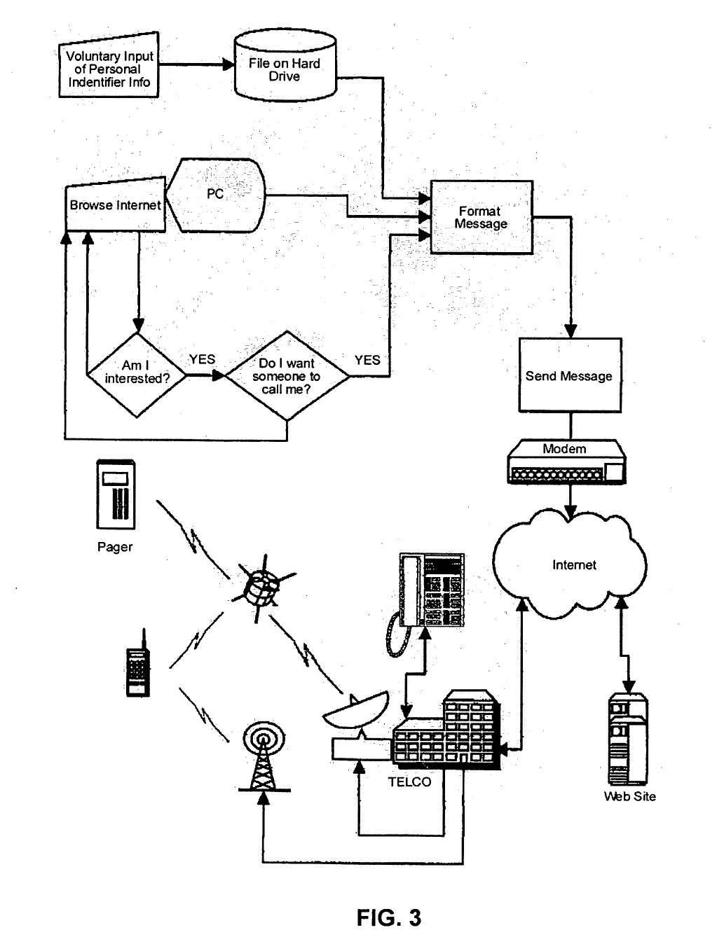

This example is represented graphically in FIG. 3.

### EXAMPLE 2

### Document Authentication

The second embodiment of the invention uses the unique identifier and the messaging facility to authenticate a document. One of the problems with electronic documents is that they are especially hard to authenticate. Even faxes, that were once considered a safe form of transmission, can easily be tampered with electronically prior to them being printed. Using the unique identifier combined with the document properties a checksum can be generated and stored within the document by the sender. At the receiving end, the document can be authenticated by comparing the checksum with the identifier and document properties. The only real form of authentication is through verbal exchange. Using the message passing property the authentication process can initialize a phone call.

In this embodiment both the sender and receiver of the document are clients that have previously registered with the UIDBXS and have been given a unique identifier. As an extension of the registration process the clients are issued with the necessary unique identifier checksum generating software (UICGS). This is used by both users to authenticate the document.

Before sending the document the sender runs the UICGS. The UICGS communicates with the UIDBXS to retrieve the correct unique identifier. This is combined with the document properties to form the checksum that is appended to the document.

At the receiving end the document can be checked again using the UICGS. This time the UICGS extracts both the unique identifier and the document properties from the checksum. By comparing the document properties with the document, any modifications can be detected. In addition the receiver is requested to check that the unique identifier matches the sender. In the case that doubt still exists a facility can be provided in the authentication process to message the sender. For example, using embodiment 1, the message is sent to the sender requesting immediate verbal confirmation on the document's authenticity. When the sender makes the call, verbal communication is established and the document is fully verified.

### EXAMPLE 3

### Internet Phone Polling

Prior to elections or to get an idea of market reactions specialist phone polling companies ring a sample of voters, or potential customers and quiz them on the political preferences, views, options, purchasing habits and numerous other matters. This type of polling has been used on the Internet, but one of the unavoidable problems is that people can access the same site multiple times, and thus vote more than once. The unique identifier part of this invention can be used to record people who have voted in a particular poll, thus they can be restricted to one vote. A modification would be to allow people to submit multiple votes, but only include the latest one. This would mean that a “current” vote could be maintained. This embodiment requires the voter to be at least a user of the system and thus, must have been allocated a unique identifier.

When the client logs into the voting web site a cookie will be sent from their computer to the website. The web site can access the cookie details, authenticate the client from the UIDBXS and determine whether the user has previously accessed the poll. Depending on the style and nature of the poll, the user may or may not be allowed to vote multiple times.

### EXAMPLE 4

### Demographic Data

An extension of example 3 is to develop demographic data about the user, their habits, lifestyle, consumer preferences etc. Again, this embodiment relies upon the unique identifier aspect of the invention. The subject must be a client of the system, and as such must have completed the registration as with examples 1 and 2.

As an additional step in the registration process the client can be asked to participate in a live survey that details computer usage, Internet traffic and consumer preferences etc. To encourage support an incentive could be provided to the use of examples 1 to 3.

If the user agrees to participate, a recording program is issued to the client. This program would be resident in memory from boot up (included in start up) and would record details such as which web sites were accessed, how long Word was run for, how long the computer is used for etc. The data would be cached until it is up loaded to the web server.

When the user initially logs into the Internet the data, previously cached is transferred to the web server and then removed. The design of both the recording and the transmitting processes would have to be such that they do not interfere with the normal operation of the computer.

### EXAMPLE 5

### Event Messaging

The messaging market is the ability to notify people of events. Whether they be sport, news, work or security related, the ability to transmit a concise message instantly to a third party is becoming increasingly important.

The event messaging embodiment of this invention services those businesses and services that require regular updates. For example, a broker may need to be kept informed of the latest share prices, or a real estate agent may need to be informed when a client get loan approval.

An application of the invention would be for a bank that approves home loans. As loans are approved the bank's computer system is updated. This sends an email to the system. After processing the email the relevant people (broker, real estate agent, client) are simultaneously messaged informing them of the approval.

In this particular example, the actual input module for the event messaging is email based. This allows companies to “dump” a large number of messages in a pre-specified format that then can be processed at the database. For the client this means that they do not have to open a connection and follow a set of protocol delimiters that effectively talk to the database (view to TCP/IP). Instead, the company can reduce their output to an email, message or the like.

### EXAMPLE 6

The embodiment is directed towards an on-line messaging system for use on the Internet or any other format as an adjunct to web sites that are either selling products or provide information on any matter, or to facilitate personal communication.

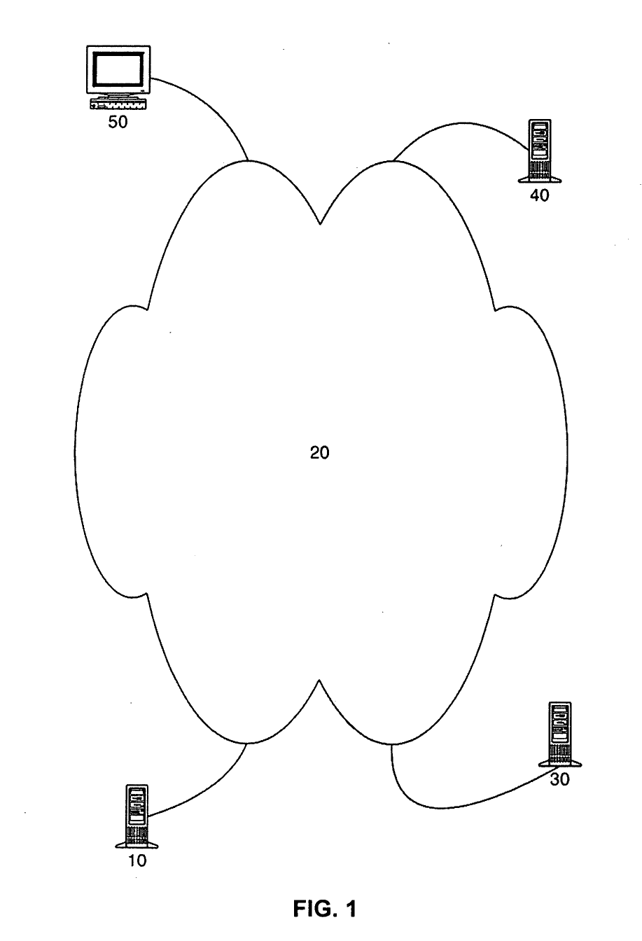

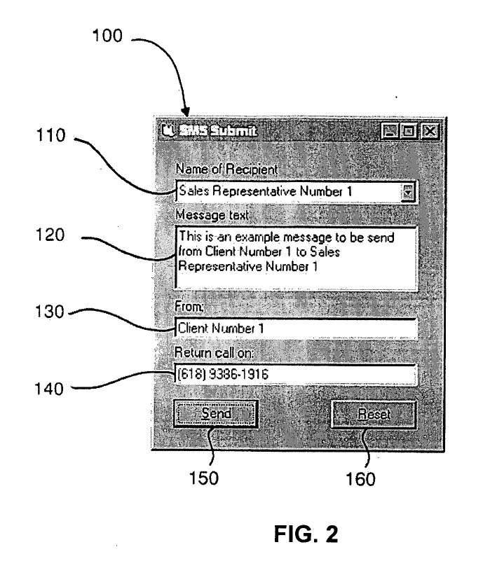

As illustrated in FIGS. 1 and 2, the on-line messaging system of the embodiment is implemented as computer software executing on a computer 10. The computer 10 is connected to the Internet 20. Also connected to the Internet 20 is a telephone carrier computer 30, a host computer 40 for a web-based company or any other group or individual and a users computer or other interactive system such as, but not restricted to, a Digital TV 50.

It should be appreciated that in the embodiment, the web-based company is shown as having its own host computer 40, whereas its web pages may simply be resident on an Internet service provider or other computer system.

Each of the computers 10, 40 and 50 (or Digital TV) are Interconnected via the Internet 20. A user browsing the Internet 20 using the computer 50 (or other interactive system) may access the web page residing on the computer 40. The web page stored on the computer 40 includes buttons either next to each product or service for sale or generally placed to enhance communication that invite the user to press them if they wish to be contacted by a salesperson, employee or individual (or group thereof).

If one of the buttons is pressed, the computer (or Digital TV) 50 presents a pop-up window to the user using languages such as, but not restricted to, HTML or JAVA or any equivalents. FIG. 2 shows one such pop-up window 100.

The pop-up window 100 includes a drop-down list 110 from which the user can select a name of a sales person, company representative or individual he/she wishes to be able to speak to. In other embodiments, the drop-down list 110 could be omitted if there was only one sales representative or individual. Further, in a selling situation, the drop-down list 110 could be replaces with another drop-down list from which the user could select a product they wish to speak to a sales representative about.

In this example the pop-up window 100 also includes a first text box 120, a second text box 130 and a third text box 140, and a send button 150 and a reset button 160. In the first text box 120, the user can enter a message, if desired. The user's name and phone number are entered into the second and third text boxes 130 and 140, respectively. It is envisaged that the information contained in the second and third text boxes 130 and 140 can be derived from user preference files, such as cookies or browser preferences. In such a configuration, the user need not enter a text message in the first box 120 at all if desired, since the essential information, their name and return phone number, already appear in the second and third text boxes 130 and 140.

Once the user has completed the details in the pop-up window, the send button 150 is pressed. Once activated the user's contact information is automatically registered within their own computer or other interactive system for all future use on any Web Page they select from that computer or other interactive system. Upon doing so, the information entered by the user is sent to the computer 10 via the Internet 20. The information includes:

the concentrated text from text boxes 120, 130 and 140;

the web page identifier or other unique identifier of the request;

the destination phone number.

Note that not all of the above information is presented to the user. For instance, the destination phone number is contained within the program. The user refers to the name or product.

Upon receipt of the information, the on-line messaging system executing on the computer 10 operates as follows:

Firstly, the on-line messaging system translates the information and ensures the data is in a valid format. Next, from the unique identifier, the owner of the web page is identified and their counter is incremented for statistical purposes and also for future billing reference.

Next, the on-line messaging system translates the received information into a format suitable for sending to a carrier. To achieve this, firstly the on-line messaging system analyses the destination phone number, and in particular analyses the prefix of the destination phone number. From the prefix, the on-line messaging system determines the carrier for that phone number by reference to a database.

Table 1 below shows a sample look-up table forming part of the database.

TABLE 1

| Prefix | Carrier |
|---|---|
| 0411 | Optus |
| 0412 | Optus |
| 0413 | Optus |
| 0414 | Vodaphone |
| 0415 | Vodaphone |
| 0416 | Vodaphone |
| 0417 | Telstra |
| 0418 | Telstra |
| 0419 | Telstra |

The on-line messaging system compares the first four digits of the destination mobile telephone number with the prefixes listed in Table 1. Once a matching prefix is located, the corresponding carrier is then referenced from Table 1.

The database also includes a further table that stores, for each carrier, how to compose a message and contact details for the carrier. One example of such a table is set out in Table 2 below.

TABLE 2

| Carrier | Message composition string | IP Address | Port No. |
|---|---|---|---|
| Telstra | “’.<USR>,<PWD>,.<PH_NO>,<MSG>.” | Telstra.com.au | 7000 |
| Optus | “-,PH-NO>\|<MSG>\|<USR>\|<PWD>\|<SERVERID>-“ | Optus.com.au | 4000 |
| Vodaphone | “//<PHNO>-<MSG>//” | Vphone.com.au | 6000 |

Next, the on-line messaging system references the database and determines for the carrier, the appropriate message format for that carrier. Next, the on-line messaging system constructs a message in the appropriate format for the carrier. This may include start and stop commands, text delimiters and so forth.

In the embodiment, the message format is constructed by referencing the message composition string shown in Table 2 for that carrier. The message composition string may contain the following fields:

| Field | Description |
|---|---|
| <USR> | User Name |
| <PWD> | Password |
| <PH_NO> | Mobile phone number to send the message to |
| <MSG> | The message to be sent to the mobile phone |
| <SERVERID> | The server from which the data is being sent |

The fields <PH_NO> and <MSG> are derived from the information received by the on-line messaging system. The remaining fields <USR>, <PWD> and <SERVERID> pertain to access to the carrier and these values are referenced elsewhere within the database.

Next, the on-line messaging system again references the database to determine details of how to send the message to the carrier. In this regard, the database includes contact information for each carrier. The contact information may take the form of an IP address, including user name and password information, or alternatively a phone number to be called or other appropriate information.

Based on the contact information, the on-line message system forwards the constructed message to the carrier.

For instance, where the carrier's computer is connected to the Internet, such as the case of the carrier computer 30, the contact information stored in the database for that carrier includes the IP address of the carrier computer 30. The on-line messaging system 10 then forwards the message information to the carrier computer 30 via the Internet 20.

Thus it will be appreciated that in the embodiment described above the signalling apparatus of the present invention facilitates interactive communication between clients providing services and/or products and prospective users thereof, and comprises a database (in computer 40) of at least one client's user interest data on a network, a remote interface 50 permitting network access to the user interest data by a user, selection by the user of a client's user interest data and entry by the user of user-specific data, processing software (in computer 10) which merges the user-specific data and the selected user interest data to produce response data, and a response module (in computer 30) which automatically exports the response data to at least one recipient nominated by the client.

The embodiment provides a convenient mechanism that companies with sales web pages on the Internet can use to ensure customers browsing their products can quickly access a sales representative and thereby increase the chance of a successful sale.

It should be appreciated that the invention is not limited to a particular embodiment, such as example 6 described above.

For example, the language used to generate the pop-up window can be altered according to the needs of the developer. Further, the pop-up window can provide a variety of different features, including a list of products or names from which the user can select. Each product may result in a different unique, identifier sent to the on-line messaging system and each name may result in a different destination telephone number. Further, other client/server arrangements can be adopted without departing from the invention.

Further, it should be appreciated that the information in the database can be arranged in a variety of ways without departing from the spirit of the invention.

Further, any other form of interactive web page based system can be adopted without departing from the spirit of the invention.

Further, it is envisaged that the database may include a list of destination phone numbers so that the destination phone number is not transmitted over the Internet 20. In this instance, the destination phone number will be determined from the unique message identifier. Note that the message identifier need not be unique for every single message information sent across the Internet 20, since its purpose is simply to identify to the on-line messaging system, the owner of the web page from which the message was sent and, depending upon the owner of the web pages needs, more detailed information such as the selected product and-or salesperson.

### EXAMPLE 7

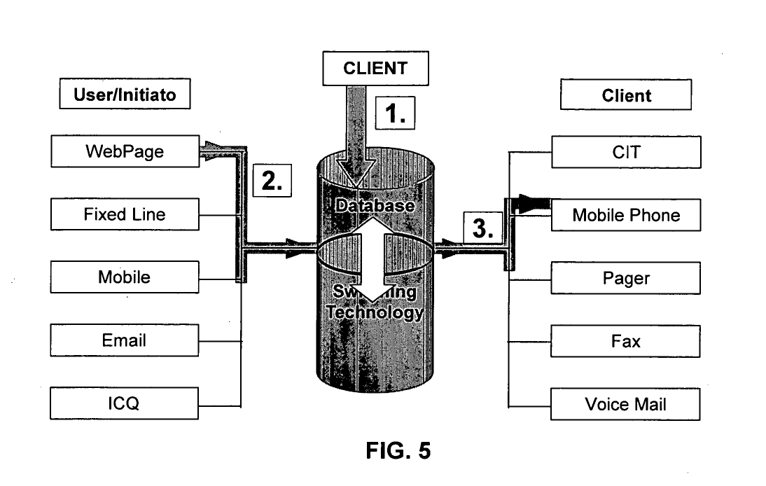

The various embodiments enable communication between parties across differing media and devices. In most situations, one of the parties is a client who requires a service. To provide this service, a three-stage process is utilised, as illustrated in FIG. 5:
1. The client registers to the system information required to complete the service. This information is stored in the database. (e.g. clients phone and name details etc.)
2. The database receives information from the user that is to be directed to a nominated client and device. (e.g. users contact details transferred to PISCES database on the click of a button.)
3. The engine packages the information and using switching technologies routes the information to the relevant client's communication device. (e.g. SMS message containing user contact details sent to the clients mobile phone, pager etc.)

There are three main components:

Proprietary Code (Information Source)

This is the code that exists on the Webpage of the client, or is integrated into their existing system. It is generated by a Server Side Database and is used to initiate the process. In the case of event messaging, this code can exist as a patch to existing programs and needs to be custom written to suit the application in question.

Server Side Engine (Communication Engine)

The server-side engine is responsible for receiving the information to be forwarded to the nominated party, retrieving information from the database on the contact details on the receiver, packaging the information and sending the information via the appropriate medium using TCP/IP.

Server Side Database (Database)

The database is used as the administration point for our client. A web-based login allows them to add and modify details as required and also to generate the code relevant to the buttons they create. This database allows the client to customise their payment schedule and other services such as email monitoring. No information is held on the client's computer.

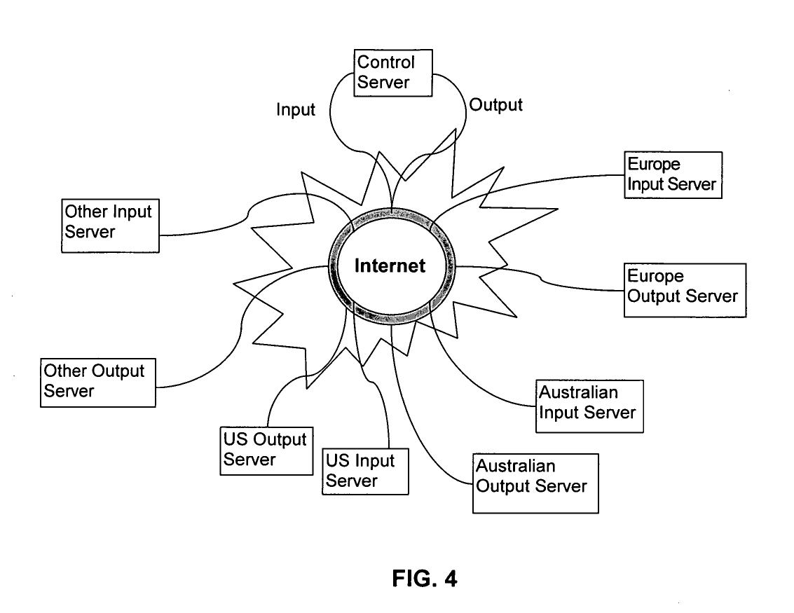

The system processes an incoming message, event or trigger and sends a message to one, or multiple destination addresses. FIG. 4 shows an example of this application on a world-wide scale.

Consider the event messaging example: An event occurs in a client's business process. This triggers the sending of an email (from the information source). The email arrives at the system and is processed by the communication engine. After processing, the Database is consulted and an appropriate action is taken. This will generally involve sending a message to notify someone. The message is sent by the communication engine.

FIG. 4 illustrates a target system. The three components are broken down by region and by functionality. There are four input servers (US, Europe, Australia and other) and four output servers. These take the role of the communication engine. However, they also function as the database. In each location portions of the database is mirrored to improve efficiency. Although not shown on the FIG. 4, the clients' systems contain the relevant proprietary code that acts as the information source.

The purpose of having multiple servers is that the different communication functions can be broken down by type, physical location and by whether they are Input or output. It also helps to facilitate load balancing between servers to improve efficiency. To ensure that each of the servers has up to date information they are all connected to the Internet and can be administered by the Central Server.

A more complex example would be a “click-of-the-button” Website in Europe. When someone (located in Australia) clicks the button the web server send a packet of information (either email or URL encoded) to the nearest system server (in this case the Australian Input server), which processes the information. If the portion of the databank contained on the Australian Input Server doesn't contain the relevant information, a request is sent to the Central Server. This in turn will locate the relevant information (perhaps off the US Output Server) and return it to the Australian Input Server. As the web site is located in Europe (and thus the client is located in Europe), the Australian Input Server communicates with the Europe Output Server to send the message to the client.

It will of course be realized that while the above has been given by way of illustrative example of this invention, all such and other modifications and variations thereto as would be apparent to persons skilled in the art are deemed to fall within the broad scope and ambit of this invention as is herein set forth.

1. A method of facilitating interactive communication between clients providing services and/or products and prospective users thereof, the method comprising:
providing access to a database of at least one client's user interest data on a network;
permitting network access to the user interest data by a user via a remote interface;
receiving a selection by the user of the client's user interest data;
receiving entry by the user of user-specific data;
providing access to processing software which processes the user-specific data and the selected user interest data to produce response data, and
providing at least one recipient nominated by the client with access to equipment which automatically exports the response data.

2. A method of facilitating interactive communication as claimed in claim 1, the method further comprising:
establishing and/or maintaining the database.

3. A method of facilitating interactive communication as claimed in claim 1, the method further comprising:
processing the user-specific data and the selected user interest data to produce the response data.

4. A method of facilitating interactive communication as claimed in claim 1, the method further comprising:
automatically exporting the response data to the at least one recipient.

5. Signalling apparatus according to claim 2, wherein a client-specific identifier for each client is stored in the database.

6. A method of facilitating interactive communication as claimed in claim 5, wherein the database comprises at least one of: a web server database, a subscriber database, an open user group database, and a closed user group database.

7. A method of facilitating interactive communication as claimed in claim 1, wherein the user-interest data requires or elicits a user-specific response from the user.

8. A method of facilitating interactive communication as claimed in claim 1, wherein the user-interest data comprise at least one of: product information and service information.

9. A method of facilitating interactive communication as claimed in claim 1, wherein the user-interest data comprise information relating to the client's users and potential users.

10. A method of facilitating interactive communication as claimed in claim 1, wherein the interface is a user interface.

11. A method of facilitating interactive communication as claimed in claim 10, wherein the user interface is at least one of: a command interface, a graphic user interface (GUI), a web browser front-ending the graphic user interface of a personal computer, an interactive digital television, an application program interface.

12. A method of facilitating interactive communication as claimed in claim 1, wherein the user-specific data comprise at least one of contact details, a message, instructions, or details of an event.

13. A method of facilitating interactive communication as claimed in claim 1, wherein the response data is exported via at least one of the telephone, GSM, SMS, TTY, email and ICQ.

14. A method of facilitating interactive communication as claimed in claim 1, wherein the response data is directed to a third party.

15. A method of facilitating interactive communication as claimed in claim 1, further comprising at least one of screening, filtering and monitoring the user-specific data.

16. A method of facilitating interactive communication as claimed in claim 1, wherein the user-specific data comprises a phone number.

17. A method of facilitating interactive communication as claimed in claim 16, wherein the phone number is exported to a third party.

18. A method of facilitating interactive communication as claimed in claim 1, further comprising utilising a computer system associated with the user to notify the database of an event.

19. A method of facilitating interactive communication as claimed in claim 1, further comprising assigning the user a unique identifier upon a first receipt of user-specific data.

20. A method of facilitating interactive communication as claimed in claim 19, wherein the identifier is sent back to the user as a cookie.

21. A signalling apparatus for facilitating interactive communication between clients providing services and/or products and prospective users thereof, the signalling apparatus comprising:
a database of at least one client's user interest data on a network;
a remote interface permitting network access to the user interest data by a user, selection by the user of a client's user interest data and entry by the user of user-specific data;
processing software which merges the user-specific data and the selected user interest data to produce response data; and
a response module which automatically exports the response data to at least one recipient nominated by the client.

22. A signalling apparatus as claimed in claim 21, wherein the response module comprises a switch.

23. A method for a user to interactively communicate with a client providing services and/or products, the method comprising:
accessing a database of at least one client's user interest data on a network via a remote interface;
selecting user interest data and entering user-specific data whereby processing software is accessed which processes the user-specific data and the selected user interest data to produce response data which is then automatically exported to at least one recipient nominated by the client, and
communicating with the at least one recipient.

24. A document validation method comprising the steps of providing software on the network to users thereof, the software providing an encrypted key on documents provided by the user, the encrypted key comprising user-specific data and each key being encrypted by the document whereby tampering is evident, and enabling the same or another user to receive such documents and determine the identity of the sender from the user-specific data.

25. A method of validating the transmission of an electronic document over a network between users thereof, the method comprising:
providing access to a database of user-specific data on the network;
permitting access by a user to the database via a remote interface whereby the user may transmit an electronic document to a recipient nominated by the user;
receiving entry by the user of user-specific data;
encrypting the user-specific data;
providing access to processing software which processes the encrypted user-specific data and data corresponding to the electronic document to produce encrypted document-specific transmission data, and
providing the recipient with access to equipment which automatically exports the transmission data.

26. A method of validating the transmission of an electronic document as claimed in claim 25, the method further comprising:
processing the encrypted user-specific data and data corresponding to the electronic document to produce encrypted document-specific transmission data.

27. A method of validating the transmission of an electronic document as claimed in claim 25, the method further comprising:
automatically exporting the transmission data over the network to the recipient nominated by the user.

28. A method of validating the transmission of a document as claimed in claim 25, wherein upon receipt by the recipient of the exported transmission data it is evident if the document has been tampered with.

29. A method of validating the transmission of a document as claimed in claim 25, wherein upon receipt by the recipient of the exported transmission data the identity of the user transmitting the document is evident.

30. A method of validating the transmission of a document as claimed in claim 25, wherein upon receipt by the recipient of the exported transmission data the user transmitting the document is automatically alerted if it is evident that the document has been tampered with.
